(19) United States
(12) Patent Application Publication
(10) Pub. No.: US 2007/0131124 A1
(43) Pub. Date: Jun. 14, 2007

(54) Printing plate, method of manufacturing the printing plate, roll printing apparatus including the printing plate, and method of manufacturing display device using the roll printing apparatus

(75) Inventors: Jeong-uk Heo, Seongnam-si (KR); Bong-sung Seo, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/591,047

(22) Filed: Nov. 1, 2006

(30) Foreign Application Priority Data
Dec. 12, 2005 (KR) 10-2005-0121845

(51) Int. Cl. B41F 5/00

(52) U.S. Cl. 101/216

(57) ABSTRACT

A printing plate, a method of manufacturing the printing plate, a roll printing apparatus including the printing plate, and a method of manufacturing a display device using the roll printing apparatus are provided. The roll printing apparatus includes a printing plate including an array of a plurality of grooves arranged equally spaced in a first direction, having substantially the same depth as a cell gap of a display panel including two opposing substrates, and extending in a second direction perpendicular to the first direction such that a distance between each of the plurality of grooves is greater at an end line than at a start line, and a transfer roller including a transfer sheet for transferring ink that is filled in the plurality of grooves to one of the substrates.

### CROSS-REFERENCE TO RELATED FOREIGN APPLICATIONS

This application claims priority from Korean Patent Application No. 10-2005-0121845 filed on Dec. 12, 2005 in the Korean Intellectual Property Office, the contents of which are incorporated herein by reference in their entirety.

### BACKGROUND OF THE INVENTION

1. Field of the Invention

The present invention relates to a roll printing apparatus, and more particularly to, a roll printing apparatus using a blade, a method of forming ink patterns and a method of manufacturing a liquid crystal display using the roll printing apparatus.

2. Description of the Related Art

With the development of the information society, various demands for display devices are increasing, and research for flat panel displays such as LCDs (Liquid Crystal Displays), ELDs (Organic Electro Luminescent Displays), FEDs (Field Emission Displays), or PDPs (Plasma Display Panels) is actively ongoing to replace the CRTs which have been conventionally widely used in display devices such as televisions or computer monitors.

A flat panel type display device includes first and second substrates which have different functions and face to each other. The first and second substrates are separated from each other by a predetermined distance, and spacers are interposed between the first and second substrates to uniformly maintain a cell gap between the first and second substrates.

As the spacers, bead spacers and column spacers are used. The bead spacers are formed mainly using a dispersing method. The dispersing method is simple and cost-effective. However, the dispersing method has a difficulty in precisely controlling the positions of spacers, and thus, beads may be dispersed in pixel regions, thereby decreasing image quality.

The column spacers are formed mainly by patterning an organic material using a photolithography process, and thus can be relatively accurately formed at desired positions. However, the photolithographic patterning method is complicated, thereby increasing process duration and costs.

Recently, a printing method using a roll printing apparatus has been studied as a substitute for the dispersing method and the photolithography method. The printing method can be easily performed within a short time in a cost-effective manner.

The printing method can more accurately form an array of spacers on desired positions than the dispersing method, but may involve a transfer error according to the characteristics of a transfer sheet. As the size of a substrate increases, the rolling distance of the roll printing apparatus increases, and thus, the transfer error increases. When spacers are inaccurately formed due to the transfer error, a cell gap may not be effectively maintained. In addition, cumulative transfer error in pixel regions may reduce an aperture ratio, thereby resulting in a reduction in image quality.

### SUMMARY OF THE INVENTION

An embodiment of the present invention provides a roll printing apparatus capable of accurately forming ink patterns even on a large-sized substrate.

An embodiment of the present invention also provides a printing plate used in the roll printing apparatus.

An embodiment of the present invention also provides a method of manufacturing the printing plate.

An embodiment of the present invention also provides a method of manufacturing a display device using the roll printing apparatus.

According to an aspect of the present invention, there is provided a roll printing apparatus including a printing plate including an array of a plurality of grooves arranged equally spaced in a first direction, having substantially the same depth as a cell gap of a display panel including two opposing substrates, and extending in a second direction perpendicular to the first direction wherein a distance between each of the plurality of grooves is greater at an end line than at a start line, and a transfer roller including a transfer sheet adapted to transferring ink that is filled in the plurality of grooves to the substrate.

According to another aspect of the present invention, there is provided a printing plate including an array of a plurality of grooves having substantially the same depth as a cell gap of a display panel including two opposing substrates, wherein the plurality of grooves are arranged equally spaced in a first direction and extend in a second direction perpendicular to the first direction, a distance between each of the plurality of grooves being greater at an end line than at a start line.

According to still another aspect of the present invention, there is provided a method of manufacturing a printing plate, the method including filling an array of a plurality of grooves formed on a test printing plate with ink, wherein a distance between each of the plurality of grooves is the same as a distance between spacers of a display panel including two opposing substrates, rolling a transfer roller including a transfer sheet on the test printing plate to transfer ink patterns from the grooves to the transfer sheet, retransferring the ink patterns from the transfer sheet to a test substrate, and comparing a distance between the ink patterns retransferred to the test substrate and a distance between the spacers and correcting the distance between the grooves.

According to yet another aspect of the present invention, there is provided a method of manufacturing a display device, the method including filling an array of a plurality of grooves formed a printing plate with spacer-containing ink, the printing plate including an array of a plurality of grooves arranged equally spaced in a first direction, having substantially the same depth as a cell gap of a display panel including two opposing substrates, and extending in a second direction perpendicular to the first direction wherein a distance between each of the plurality of grooves is greater at an end line than at a start line, rolling a transfer roller including a transfer sheet on the printing plate to transfer ink patterns from the grooves to the transfer sheet, and retransferring the ink patterns from the transfer sheet to one of the substrates.

### BRIEF DESCRIPTION OF THE DRAWINGS

FIG. 1 is a schematic sectional view illustrating a roll printing apparatus according to an embodiment of the present invention.

FIG. 2 is a sectional view illustrating a liquid crystal display manufactured by a method according to an embodiment of the present invention.

FIG. 3 is an enlarged view of a part A of FIG. 2.

FIGS. 4 through 6 are perspective views illustrating sequential steps in a method of manufacturing a liquid crystal panel of a liquid crystal display according to an embodiment of the present invention.

FIG. 7 is a flowchart illustrating a method of forming an array of spacers of a liquid crystal display according to an embodiment of the present invention.

FIG. 8A is a plan view illustrating a printing plate according to an embodiment of the present invention, and FIG. 8B is a sectional view taken along the line B-B′ of FIG. 8A.

FIGS. 9 through 12 are sectional views illustrating sequential steps in a method of forming an array of spacers of the liquid crystal display according to an embodiment of the present invention.

FIG. 13 is a flowchart illustrating a method of manufacturing a printing plate according to an embodiment of the present invention.

FIGS. 14A and 15A are sequential plan views illustrating a method of manufacturing a printing plate according to an embodiment of the present invention, and FIGS. 14B and 15B are sectional views taken along lines B-B′ of FIGS. 14A and 15A, respectively.

FIG. 16 is a plan view illustrating a printing plate manufactured by a method according to an embodiment of the present invention.

FIG. 17 is a plan view illustrating a printing plate according to another embodiment of the present invention.

FIG. 18A is a perspective view illustrating a printing plate according to still another embodiment of the present invention, and FIG. 18B is a sectional view taken along the line B-B′ of FIG. 18A.

FIG. 19 is a sectional view illustrating a method of forming an array of spacers using the printing plate shown in FIG. 18A.

FIG. 20 is a sectional view illustrating a printing plate according to yet another embodiment of the present invention.

### DETAILED DESCRIPTION OF THE EXEMPLARY EMBODIMENTS

Features of embodiments of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

A roll printing apparatus according to an embodiment of the present invention will now be described.

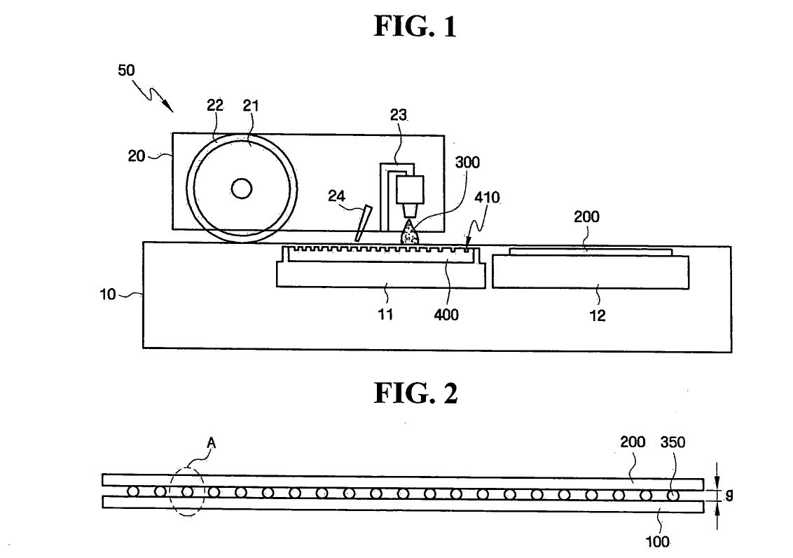

FIG. 1 is a schematic sectional view of the roll printing apparatus according to an embodiment of the present invention.

Referring to FIG. 1, a roll printing apparatus 50 is used to print various ink patterns on a display panel, and includes a printing plate 400, and a transfer roller 21 transferring ink filled in the printing plate 400 to the display panel. Various ink patterns can be printed using the roll printing apparatus 50. However, an exemplary, non-limiting embodiment of the present invention will be illustrated hereinunder in view of forming the array of spacers for maintaining a cell gap between display panels of a display device.

The printing plate 400 includes an array of grooves 410 to form the array of spacers, which is a target pattern. Here, each of the grooves 410 corresponds to each spacer of the array of spacers. Each spacer of the array of spacers may include a single unit spacer but embodiments of the present invention are not limited thereto. Each spacer of the array of spacers may also include a set of unit spacers. The array of the grooves 410 will be more specifically described below.

The printing plate 400 is received in a printing plate support 11 installed at a lower frame 10. A substrate support 12 is disposed parallel to the printing plate support 11 at the lower frame 10. A target substrate 200 such as a display panel is disposed on the substrate support 12, and ink printing is performed thereon.

The transfer roller 21 is disposed above the printing plate 400. The transfer roller 21 may have a cylindrical shape, and an outer surface of the transfer roller 21 is covered with a transfer sheet 22. The transfer sheet 22 is made of a material having good adhesion to ink 300. For example, the transfer sheet 22 may be made of silicone with high hydrophilicity. The transfer sheet 22 may have elasticity or low hardness to promote a transfer of ink patterns from the printing plate 400 to the transfer sheet 22 and a retransfer of the ink patterns from the transfer sheet 22 to the target substrate 200.

The transfer roller 21 is disposed at an upper frame 20 which moves reciprocally with respect to the lower frame 10. For example, the lower frame 10 may be fixedly disposed, whereas the upper frame 20 may be disposed to move reciprocally along an upper surface of the lower frame 10. At this time, the upper frame 20 is positioned to be close to the lower frame 10 so that the transfer sheet 22 covering the transfer roller 21 is contacted to an upper surface of the printing plate 400 and/or the target substrate while rotating the transfer roller 21. Although the transfer sheet 22 does not need to contact the upper surface of the target substrate, at least a distance between the transfer sheet 22 and the target substrate must be maintained so that the ink patterns transferred to the transfer sheet 22 may contact the upper surface of the target substrate.

The upper frame 20 may further include an ink supply device 23 and a blade 24. The ink supply device 23 and/or the blade 24 may be disposed in front of the transfer roller 21 with respect to the rolling direction of the transfer roller 21.

The blade 24 may be disposed at the back of the ink supply device 23, and have a wide width corresponding to the full width of the array of the grooves 410. The blade 24 fills the ink 300 in the grooves 410 and removes residual ink on the upper surface of the printing plate 400.

A display device manufactured using a roll printing apparatus including the printing plate according to an embodiment of the present invention and a method of manufacturing the display device will now be described. In the following description, while the display device using the manufacturing method of an embodiment of the present invention is illustrated with regard to an LCD by way example, the invention is not limited to the illustration and can applied to FEDs, organic EL devices, PDPs, and so on.

First, a liquid crystal panel of a liquid crystal display manufactured using a roll printing apparatus according to an embodiment of the present invention will be described. FIG. 2 is a sectional view illustrating a liquid crystal display manufactured by a method according to an embodiment of the present invention.

Referring to FIG. 2, an image-displaying liquid crystal panel of a liquid crystal display includes a first substrate 100, a second substrate 200 opposing to the first substrate 100, and a liquid crystal layer (not shown) interposed between the first substrate 100 and the second substrate 200. The first substrate 100 and the second substrate 200 are parallel to and separated from each other by a cell gap g. An array of spacers 350 are disposed in the liquid crystal layer between the first substrate 100 and the second substrate 200 to maintain the cell gap g.

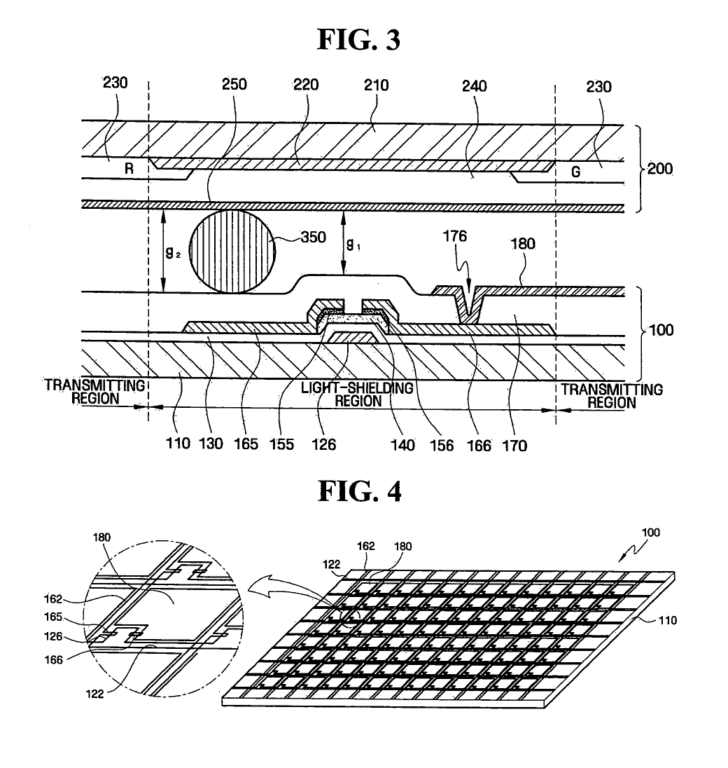

FIG. 3 is an enlarged view of a part A of FIG. 2. A liquid display panel according to an embodiment of the present invention will now be described in more detail with reference to FIG. 3.

Referring to FIG. 3, with respect to the first substrate 100, a plurality of wire patterns are disposed on a first insulating substrate 110 made of transparent glass or plastic. In detail, the plurality of wire patterns include a gate electrode 126 disposed on the first insulating substrate 110 and made of a conductive material such as aluminum (Al), copper (Cu), silver (Ag), molybdenum (Mo), Chromium (Cr), Titanium (Ti), Tantalum (Ta), or an alloy thereof, and a gate insulating film 130 made of silicon nitride (SiNx) is disposed on the entire surface of the resultant structure.

A semiconductor layer 140 made of n+ hydrogenated amorphous silicon is disposed on at least a portion the gate insulating film 130 overlapping with the gate electrode 126. Ohmic contact layers 155 and 156 are disposed on the semiconductor layer 140 so that at least a portion of the semiconductor layer 140 is exposed.

A source electrode 165 and a drain electrode 166, which are made of a conductive material such as aluminum (Al), copper (Cu), silver (Ag), molybdenum (Mo), chromium (Cr), titanium (Ti), tantalum (Ta), or an alloy thereof, and separated from each other, are disposed on the ohmic contact layers 155 and 156.

The gate electrode 126, the semiconductor layer 140, the source electrode 165 and the drain electrode 166 constitute a thin film transistor (TFT) for switching a pixel electrode 180. Here, the gate electrode 126 serves as a control terminal of the TFT, and the source electrode 165 and the drain electrode 166 serve as an input terminal and an output terminal of the TFT, respectively. The semiconductor layer 140 forms a channel region of the TFT. Meanwhile, the ohmic contact layers 155 and 156 are separated from each other in a similar manner to the source electrode 165 and the drain electrode 166, to reduce contact resistance between the ohmic contact layers 155 and 156 and the underlying semiconductor layer 140.

A passivation layer 170 made of silicon nitride, silicon oxide (SiOx) and/or an organic material is formed on the source electrode 165 and the drain electrode 166. The pixel electrode 180 made of a transparent conductive material such as indium tin oxide (ITO) or indium zinc oxide (IZO) is formed on the passivation layer 170. The passivation layer 170 is electrically connected with the drain electrode 166 through a contact hole 176 and arrayed in a matrix type.

Alternatively, an alignment layer (not shown) may further be formed on the passivation layer 170.

Next, with respect to the second substrate 200, a light-shielding pattern 220 made of an opaque metal such as chromium (Cr) or carbon black is disposed below a second insulating substrate 210 made of a transparent material such as glass or plastic. The light-shielding pattern 220 is formed in a matrix type to define a pixel region.

A color filter 230 composed of red (R), green (G), and blue (B) components is disposed below the light-shielding pattern 220. An overcoat film 240 is disposed on the entire bottom surface of the second insulating substrate 210 having the color filter 230 to attain relieved step coverage of the color filter 230. The common electrode 250 is disposed below the overcoat film 240. As described above, the common electrode 250, together with the pixel electrode 280 of the first substrate 100, form an electric field across the liquid crystal layer. An alignment film may be optionally disposed below the common electrode 250.

A spacer 350 maintains a cell gap g₁ and g₂ between the first substrate 100 and the second substrate 200.

A liquid crystal display displays images using light emitted from a backlight, etc., and a liquid crystal panel of the liquid crystal display is divided into a transmitting region and a light-shielding region according to transmission or blocking of light. A light-shielding pattern 220 of the second substrate 200, and a TFT and wires connected to the TFT of the first substrate 100 constitute the light-shielding region. An overlapping portion between a color filter 230 of the second substrate 200 and a pixel electrode 180 of the first substrate 100 constitutes the transmitting region.

The spacer 350 also constitutes the light-shielding region. In a liquid crystal display, it is important to maintain a high aperture ratio. If the spacer 350 is disposed in the transmitting region, an aperture ratio might be reduced. If the spacer 350 is disposed in a pixel region, light leakage might be caused. Thus, the spacer 350 may be disposed in the light-shielding region. For example, the spacer 350 may be disposed below the light-shielding pattern 220 of the second substrate 200.

Meanwhile, a cell gap of a liquid crystal panel may vary depending on step profiles of structures formed on the first substrate 100 and the second substrate 200. In the light-shielding region, a cell gap g₁ in a TFT region of the first substrate 100 is smaller than a cell gap g₂ in a non-TFT region of the first substrate 100. In this regard, in order to uniformly maintain a cell gap in all pixel regions, the spacer 350 may be arranged at predetermined positions. In order to minimize an impact on a TFT when the first substrate 100 and the second substrate 200 are pressed, the spacer 350 may be disposed between the light-shielding pattern 220 of the second substrate 200 and a non-TFT region of the first substrate 100.

A spherical spacer is illustrated in some figures, including FIG. 3, but the spacer 350 may also be column-shaped. That is, the shape of the spacer 350 is not limited to the illustrated example. Furthermore, the spacer 350 may also be composed of two or more unit spherical spacers.

Next, a method of manufacturing the above-described liquid crystal display panel according to an embodiment of the invention will be described. FIGS. 4 through 6 are perspective views illustrating sequential steps in a method of manufacturing the liquid crystal panel of the liquid crystal display according to an embodiment of the present invention. The method of manufacturing the liquid crystal display according to an embodiment of the present invention includes preparing first and second substrates and forming an array of spacers on the second substrate.

The first substrate 100 is first prepared. Specifically, a conductive material such as aluminum (Al), copper (Cu), silver (Ag), molybdenum (Mo), chromium (Cr), titanium (Ti), tantalum (Ta), or an alloy thereof is deposited on the first insulating substrate 110 made of, e.g., glass, and patterned to form a plurality of gate lines 122 which extend parallel with one another in a first direction, and gate electrodes 126 extending from the gate lines 122. Then, silicon nitride is deposited on the entire surface of the first insulating substrate 110 to form a gate insulating layer 130. Then, hydrogenated amorphous silicon, and n+ hydrogenated amorphous silicon highly doped with n-type impurity are deposited and patterned to form a semiconductor layer 140 and ohmic contact layers 155 and 156 having substantially the same pattern as the semiconductor layer. Then, a conductive material is deposited and patterned to form a plurality of data lines 162 which extend parallel to a second direction, source electrodes 165 connected to the data lines 162, and drain electrodes 166 spaced from the source electrodes 165, and to partially expose the underlying ohmic contact layers. Then, the exposed portions of the ohmic contact layers are patterned using the source electrodes 165 and the drain electrodes 166 as etching masks to expose the underlying semiconductor layer. Then, silicon nitride, etc. is deposited and patterned to form a passivation layer 170 having a contact hole 176. Then, indium tin oxide (ITO) or indium zinc oxide (IZO) is deposited on the passivation layer 170 and patterned to form pixel electrodes 180 electrically connected to the drain electrodes 166, thereby completing the first substrate 100.

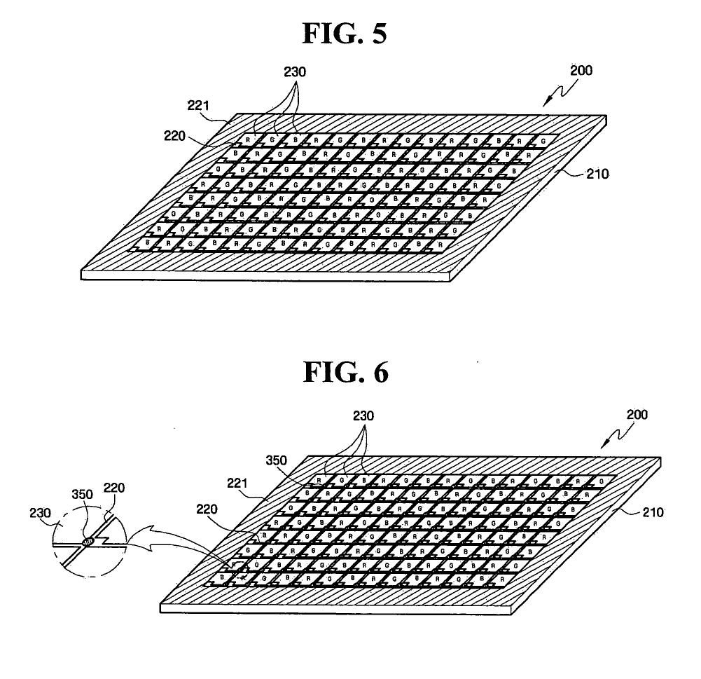

Next, the second substrate 200 is prepared. The second substrate 200 shown in FIG. 5 is reversed to that shown in FIG. 2 or 3. In the following description, one example of such change will be described in the following description. Description of the following embodiment will focus on such a reversed state as illustrated in FIG. 5. Although the illustrated state is opposite to that of FIGS. 2 and 3, persons skilled in the art will appreciate that the second substrate 200 of FIG. 5 has the same positional relationship as that of FIG. 2 or 3.

In greater detail, an opaque metal (e.g., Cr) or an opaque organic material containing carbon black is deposited on the second insulating substrate 210 and patterned to the light-shielding patterns 220 and 221. At this time, the light-shielding pattern 221 in the outermost region of the second insulating substrate 210 has a wider width than the light-shielding patterns 220 in pixel regions. Then, red photoresist is coated, exposed, and developed to form red color filter components. Then, green and blue color filter components are formed in the same manner as the formation of the red color filter components. As a result, the color filter 230 composed of the red, green, and blue components is formed. Then, an organic material, and ITO or IZO are sequentially deposited on the entire surface of the second insulating substrate 210 to form the overcoating layer 240 and the common electrode 250, thereby completing the second substrate 200.

Next, spacers 350 are formed in light-shielding regions of the second substrate 200. Each of the spacers 350 may be formed at each pixel boundary. That is, a distance between adjacent spacers 350 in a first direction may be the same as a distance between adjacent pixels in the first direction, and a distance between adjacent spacers 350 in a second direction may be the same as a distance between adjacent pixels in the second direction. Each of the spacers 350 may also be formed for every some pixels. The formation of the array of the spacers 350 will be more specifically described below.

Next, the second substrate 200 having the array of spacers 350 is disposed to face with the first substrate 100, and a sealant, etc. is coated on the peripheries of the first substrate 100 and/or the second substrate 200 to couple the first substrate 100 to the second substrate 200. Then, liquid crystal molecules (not shown) are injected between the first substrate 100 and the second substrate 200 to form a liquid crystal layer (not shown). The formation of the liquid crystal layer may also precede the coupling between the first substrate 100 and the second substrate 200. In this case, the liquid crystal layer may be formed by dropwise adding or dispersing the liquid crystal molecules on the first substrate 100 or the second substrate 200. This completes the liquid crystal panel. When polarization plates are attached to outer surfaces of the liquid crystal panel, and a backlight is disposed thereon, the liquid crystal display is finally completed.

A method of forming the array of spacers 350 according to an embodiment of the invention as illustrated in FIG. 6 will now be described in more detail. The forming the array of spacers 350 can be performed using the roll printing apparatus according to an embodiment of the present invention, which will now be illustrated.

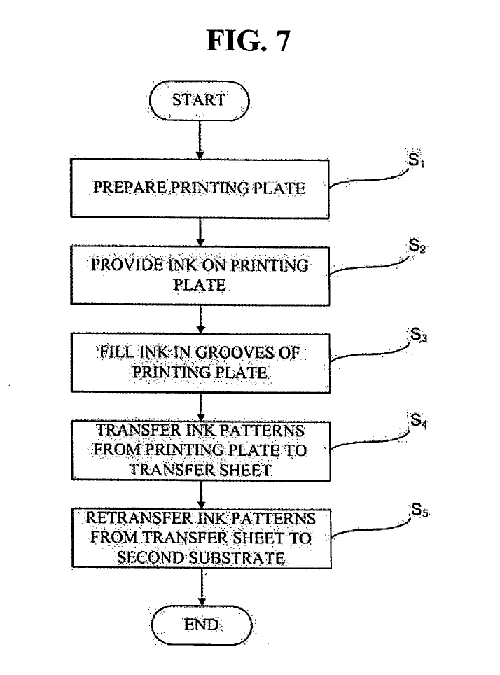

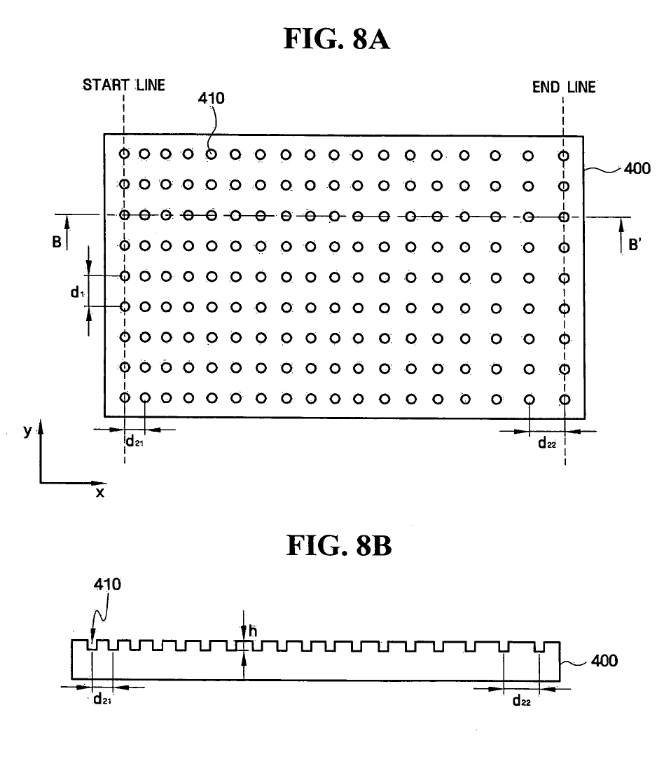

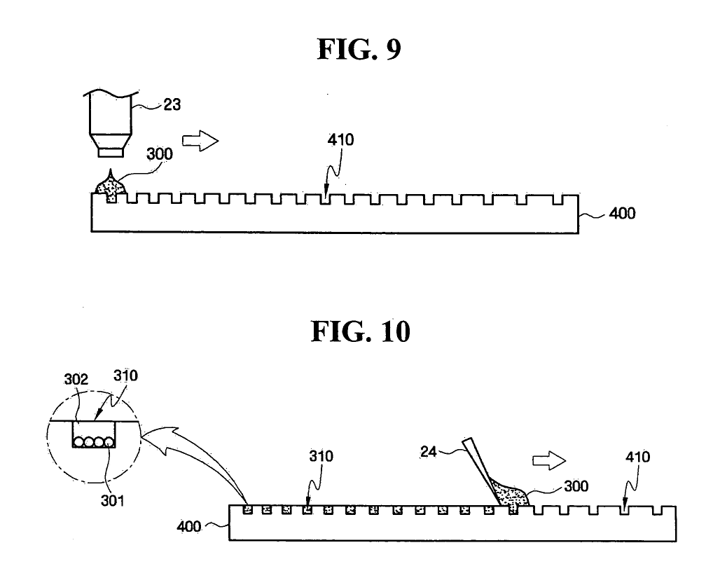

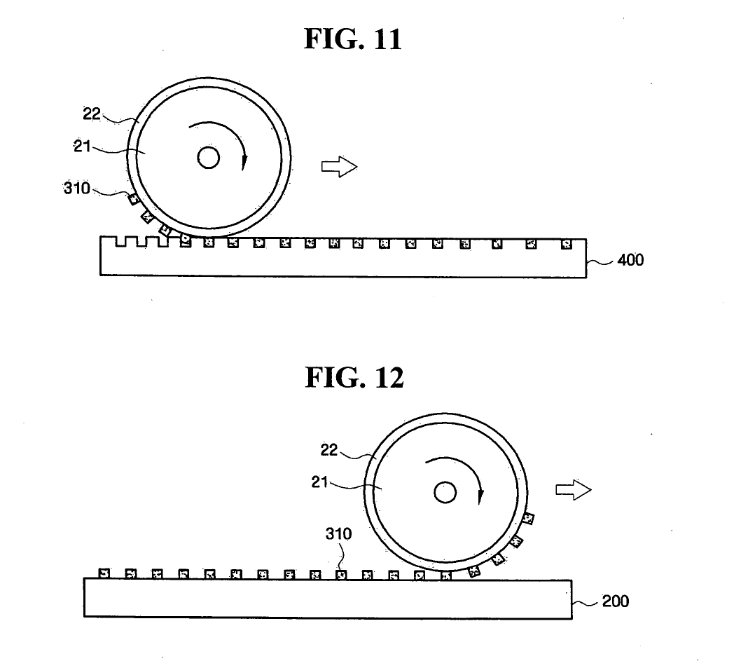

FIG. 7 is a flowchart illustrating a method of forming an array of spacers of the liquid crystal display according to an embodiment of the present invention, FIG. 8A is a plan view illustrating a printing plate according to an embodiment of the present invention, and FIG. 8B is a sectional view taken along the line B-B′ of FIG. 8A, and FIGS. 9 through 12 are sectional views illustrating sequential steps in a method of forming an array of spacers of the liquid crystal display according to an embodiment of the present invention.

First, a printing plate is prepared in operation S₁.

Next, grooves 410 are arranged on a printing plate 400. A depth h of each of the grooves 410 is substantially the same as a height of each of target spacers. As described above, a cell gap of the liquid crystal panel slightly varies depending on the presence or absence of a TFT. However, such a variation in the cell gap is negligibly small. In this regard, the height of the spacer is substantially the same as the cell gap of the liquid crystal panel, and the depth h of the groove 410 is substantially the same as the cell gap of the liquid crystal panel.

Meanwhile, when a transfer roller in the subsequent rolling process is moved in a row-wise (x-axis) direction as shown in FIG. 8A, the leftmost line of the grooves 410 where a transfer is initiated by rolling is defined as “start line”, and the rightmost line of the grooves 410 where the transfer is terminated is defined as “end line”. The grooves 410 have a constant distance d₁ in a column-wise (y-axis) direction, but a distance between the grooves 410 in the row-wise (x-axis) direction is not uniform. That is, a row-wise direction distance d₂₁ between the start and next lines of the grooves 410 is smaller than a row-wise direction distance d₂₂ between the end and preceding lines of the grooves 410. A row-wise direction distance between the grooves 410 may increase from the start line to the end line. A distance between the grooves 410 is determined considering the degree of misalignment during a rolling process using a transfer roller and a detailed description thereof will provided below.

Next, ink 300 from the ink supply device 23 is supplied onto the printing plate 400 in operation S₂. Here, the ink 300 may include a spacer. In the case of forming a column-shaped spacer, the ink 300 may also include an organic material.

In operation S₃, the grooves 410 of the printing plate 400 are filled with the ink 300.

At this time, a blade 24 is used to fill the ink 300 in the grooves 410. For convenience of illustration, a direction from the start line to the end line of the grooves 410, i.e., a right direction as viewed from FIG. 10 is defined as “working direction”. As shown in FIG. 10, when the blade 24 is moved in the working direction in a state wherein it contacts with an upper surface of the printing plate 400, the ink 300 on the upper surface of the printing plate 400 is pushed in the working direction and filling the grooves 410. Residual ink on the printing plate 400 is removed by the blade 24. A removing blade may be further used to more efficiently remove the residual ink on the printing plate 400.

Referring to an enlarged view in the left of FIG. 10, ink patterns 310 in the grooves 410 include a bead spacer 301 and a curing agent 302, and a plurality of unit bead spacers are present in each of the grooves 410. There is no limitation to ink components and the number of bead spacers.

Next, the ink patterns 310 from the grooves 410 are transferred to a transfer sheet 22 of a transfer roller 21 in operation S₄.

In detail, the transfer roller 21 having thereon the transfer sheet 22 is rolled on an upper surface of the printing plate 400 in which the ink patterns 310 are formed in the grooves 410. At this time, the rolling direction of the transfer roller 21 is the same as the working direction. By doing so, the ink patterns 310 in the grooves 410 are transferred to the transfer sheet 22 of the transfer roller 21.

The ink patterns 310 transferred to the transfer sheet 22 are retransferred to the second substrate 200 in operation S₅.

In detail, the transfer roller 21 having the transfer sheet 22 on which the ink patterns 310 are formed is rolled on the second substrate 200 so that the ink patterns 310 are retransferred to light-shielding regions of the second substrate 200. When the ink patterns 310 are retransferred to the second substrate 200, transfer pressure is applied to the transfer sheet 22 due to the elasticity of the transfer sheet 22, thereby changing the curvature of the transfer sheet 22. For this reason, a distance between the ink patterns 310 during the retransfer becomes shortened. That is, a distance between the ink patterns 310 during the retransfer becomes smaller than a distance between the ink patterns 310 transferred to the transfer sheet 22 or a distance between the grooves 410 of the printing plate 400. In this regard, according to the present invention, when a transfer and a retransfer are carried out using the printing plate 400 where a distance between the grooves 410 in the working direction varies, the distance between the ink patterns 310 on the second substrate 200 is corrected to a predetermined uniform value. Here, a distance between the ink patterns 310 retransferred to the second substrate 200 is determined by a distance between the grooves 410 of the printing plate 400. A method of determining the distance between the grooves 410 according to an embodiment of the invention will be specifically described below.

When needed, the ink patterns 310 retransferred to the second substrate 200 may be cured. This completes an array of spacers. Meanwhile, when ink supplied from an ink supply device includes a solution without a curing agent, an array of spacers, each of which consists of a unit spacer(s), can be completed by simply drying the solution. When ink is made of an organic material, an organic material curing process using heat, light, etc. may be further carried out.

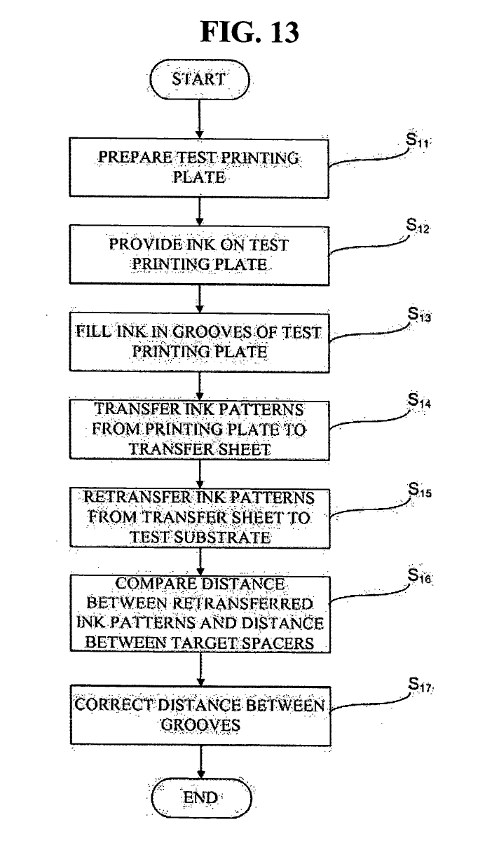

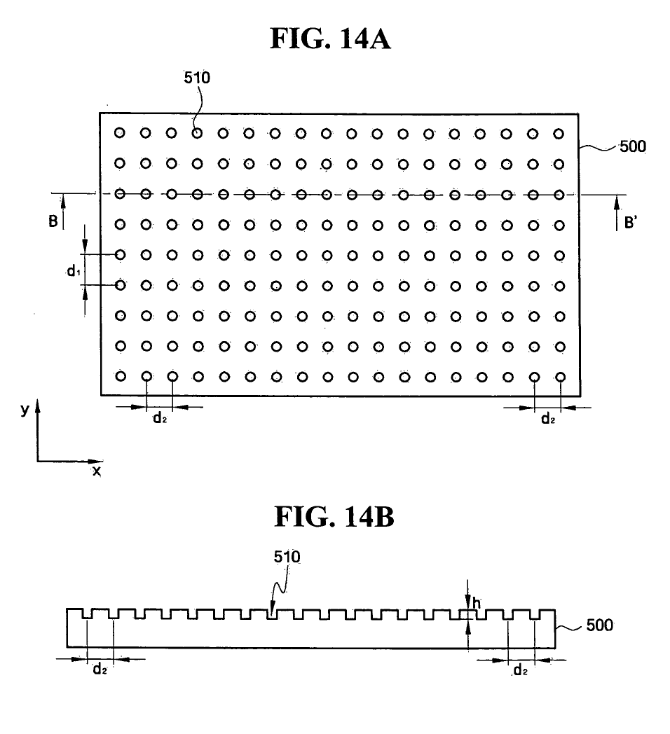

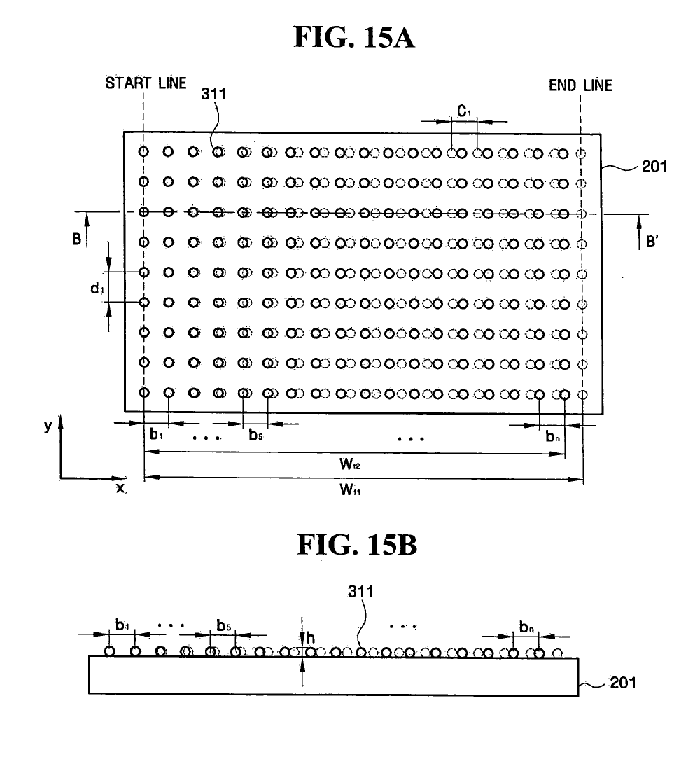

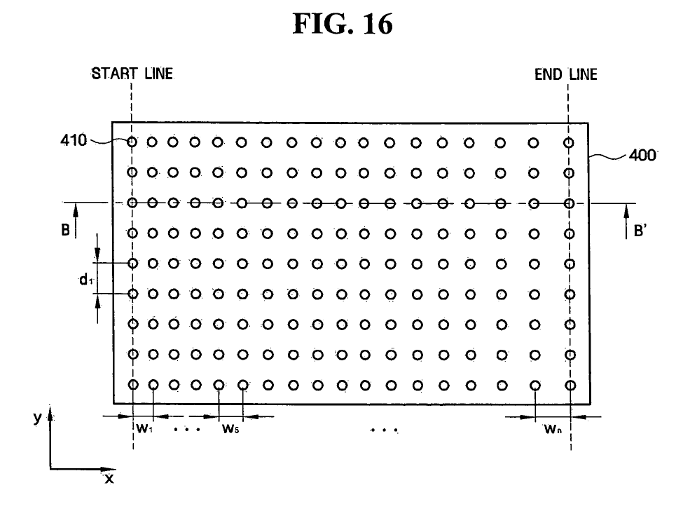

A method according to an embodiment of the invention of manufacturing a printing plate of a roll printing apparatus applied to the above-described spacer formation method according to an embodiment of the invention will now be described in more detail. FIG. 13 is a flowchart illustrating a method of manufacturing a printing plate according to an embodiment of the present invention, FIGS. 14A and 15A are sequential plan views illustrating a method of manufacturing a printing plate according to an embodiment of the present invention, FIGS. 14B and 15B are sectional views taken along lines B-B′ of FIGS. 14A and 15A, respectively, and FIG. 16 is a plan view illustrating a printing prate manufactured by a method according to an embodiment of the present invention.

First, a test printing plate is prepared in operation S₁₁.

Next, a test printing plate 500 includes an array of grooves 510. At this time, a distance d₂ between adjacent grooves 510 in a row-wise (x-axis) direction is the same as a distance between adjacent spacers of a desired array of spacers in the row-wise (x-axis) direction. That is, a distance d₁ between adjacent grooves 510 in a column-wise (y-axis) direction is constant, and the distance d₂ between adjacent grooves 510 in the row-wise (x-axis) direction is also constant.

Subsequently, in operation S₁₂, ink is printed on the test printing plate 500 in the same manner as illustrated in FIGS. 7 through 12. Specifically, ink is provided on the test printing plate 500. The ink may include spacers, but may also include only a masking material. In operation S₁₃, the ink fills the grooves 510 of the test printing plate 500 using a blade. In operation S₁₄, a transfer roller having thereon a transfer sheet is rolled along an upper surface of the test printing plate 500 to transfer ink patterns from the grooves 510 to the transfer sheet. Then, the transfer roller is rolled along a test substrate to retransfer the ink patterns from the transfer sheet to the test substrate in operation S₁₅. The test substrate may be a display plate or substrate having the same shape as a desired second substrate.

Referring to FIGS. 13, 15A, and 15B, a distance bₖ (1≦k≦n) between adjacent ink patterns 311 in a row-wise (x-axis) direction after retransfer is compared with a desired distance c₁ between adjacent spacers in the row-wise (x-axis) direction, in operation S₁₆. In FIGS. 15A and 15B, spacers arranged on a test substrate 201 are represented by dotted circles. The distance c₁ between adjacent spacers in the row-wise (x-axis) direction is constant. On the contrary, the distance bₖ between adjacent ink patterns 311 in the movement direction of a transfer roller, i.e., in the row-wise (x-axis) direction is not constant due to transfer pressure applied to a transfer sheet. The distance bₖ between adjacent ink patterns 311 in the row-wise (x-axis) direction decreases, as shown in FIGS. 15A and 15B. That is, the row-wise direction distance bₙ between the end and preceding lines of the ink patterns 311 is smaller than the row-wise direction distance b₁ between the start and next lines of the ink patterns 311.

Such a change in the distance between the ink patterns 311 in the row-wise (x-axis) direction depends on the material and thickness of the transfer sheet, etc. Furthermore, as the full width of the ink patterns 311 in the row-wise (x-axis) direction increases, i.e., as the movement distance of the transfer roller increases, a change in the distance between the ink patterns 311 in the row-wise (x-axis) direction increases. When ink is printed using a single transfer sheet, a change in the distance between the ink patterns 311 in the row-wise (x-axis) direction increases proportional to the movement distance of the transfer roller. Thus, the distance between the ink patterns 311 in the row-wise (x-axis) direction decreases as the ink patterns 311 are away from the start line. That is, the distance between the ink patterns 311 in the row-wise (x-axis) direction decreases from the start line to the end line (bₖ₋₁>bₖ).

As shown in FIGS. 13 and 16, in operation S₁₇, a target printing plate is prepared by correcting a row-wise direction distance between grooves based on the above results.

FIG. 16 illustrates a printing plate 400 including grooves 410 with a differential distance in a row-wise (x-axis) direction. That is, the grooves 410 are arranged in such a manner that a distance wₖ (1≦k≦n) between the grooves 410 increases from the start line to the end line (wₖ₋₁≦wₖ).

A method according to an embodiment of the invention of determining a row-wise direction distance between grooves will now be described in more detail with reference to FIGS. 15A, 15B, and 16.

First, a full width Wₜ₁ of a desired array of spacers in a row-wise (x-axis) direction and a full width Wₜ₂ of actually transferred ink patterns in the row-wise (x-axis) direction are measured. A full width Wₚ of a groove array of a target printing plate in the row-wise (x-axis) direction satisfies the following equation:
Wt₁:Wt₂=Wp:Wt₁, (1)

Wₚ can be calculated as follows:

$$Wp = \frac{{Wt}_{1}^{2}}{{Wt}_{2}} , \qquad ( 2 )$$

Meanwhile, assuming that distances between adjacent ink patterns in the row-wise (x-axis) direction are sequentially defined as b₁, b₂, b₃, . . . , bₙ (from the start line to the end line), and a distance between the ink patterns in the row-wise (x-axis) direction decreases proportional to the movement distance of a transfer roller, bₖ and bₖ₊₁ satisfy the following equations:

$${b}_{k} = {b}_{1} + r {\sum }_{i = 1}^{k - 1} {b}_{i} \\ {b}_{k + 1} = {b}_{1} + r {\sum }_{i = 1}^{k + 1} {b}_{i} , \qquad ( 3 )$$

where r is a proportional constant.

The following equations can be derived from Equation 3:
bₖ₊₁=(1+r)bₖ
bₖ=b₁(1+r)^{k-1}, (4)

Based on Equation 3, Wₚ can be expressed by the following equation:

$$Wp = {\sum }_{k = 1}^{n} {b}_{k} = \frac{{b}_{1} \{ 1 - {( 1 + r )}^{n - 1} \}}{r} , \qquad ( 5 )$$

The following equation can be derived from Equations 2 and 5.

$$\frac{{b}_{1} \{ 1 - {( 1 + r )}^{n - 1} \}}{r} = \frac{{Wt}_{1}^{2}}{{Wt}_{2}} , \qquad ( 6 )$$

When r is calculated from Equation 6, a distance between the grooves in the row-wise (x-axis) direction can be determined.

As described above, when ink patterns from corrected grooves of a printing plate are transferred to a transfer sheet and then retransferred to a substrate, an array of spacers having a predetermined constant distance can be formed on the substrate.

However, there is no need to strictly determine distances between grooves of a printing plate by Equation 6. If estimated distances between grooves differ slightly from the values calculated by Equation 6 without a distance between spacers being significantly affected, the difference between the calculation values and the estimation values is insignificant. That is, after the full width Wₚ of the grooves in the row-wise (x-axis) direction is determined, the grooves may be arranged such that a distance between adjacent pairs of grooves increases from the start line to the end line, based on the full width Wₚ.

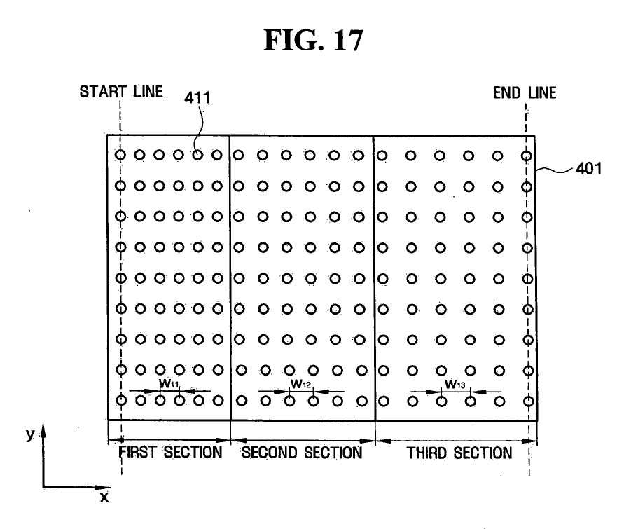

FIG. 17 is a plan view illustrating a printing plate 401 according to another embodiment of the present invention.

Referring to FIG. 17 illustrating the printing plate 401 according to another embodiment of the present invention, the printing plate 401 includes grooves 411 which are divided into two or more sections. The grooves 411 in each section are arranged equally spaced in a row-wise (x-axis) direction. FIG. 17 illustrates an exemplary, non-limiting configuration in which the grooves 411 are divided into three sections. Here, a distance w₁₃ between the grooves 411 in a third section containing the end line is greater than a distance w₁₁ between the grooves 411 in a first section containing the start line. A distance w₁₂ between the grooves 411 in a second section is greater than the distance w₁₁ and smaller than the distance W₁₃. That is, even though the grooves 411 in each section are arranged in an equally spaced fashion, a distance between the grooves 411 increases from the start line to the end line in the following order: w₁₁<w₁₂<w₁₃. Furthermore, even though the grooves 411 in each section are arranged in an equally spaced fashion, since the width of each section is smaller than the full width of the grooves 411, a distance error of ink patterns due to the arrangement of the grooves 411 in an equally spaced fashion in each section is negligible. Therefore, an array of spacers can be formed within non-TFT light-shielding regions of a substrate.

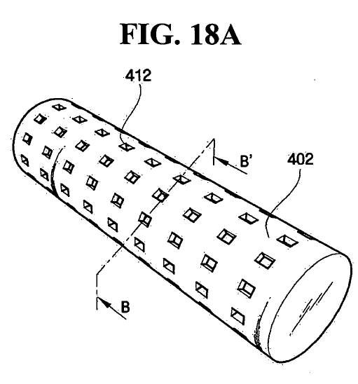

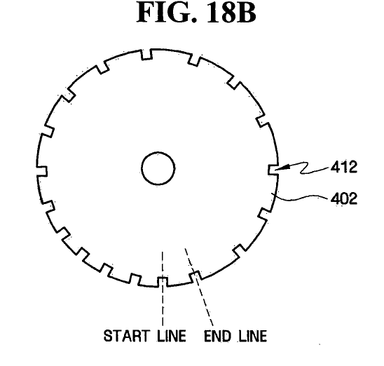

FIG. 18A is a perspective view illustrating a printing plate 402 according to still another embodiment of the present invention, and FIG. 18B is a sectional view taken along the line B-B′ of FIG. 18A, in which the printing plate 402 is substantially the same as the printing plate 400 shown in FIG. 16 except that it has a cylindrical shape.

Referring to FIGS. 18A and 18B, an array of grooves 412 is formed on outer surfaces of the printing plate 402. A distance between the grooves 412 varies along a rolling direction. That is, the distance between the grooves 412 increases from the start line to the end line. Here, the term “start line” refers to a line where transfer is initiated, and the term “end line” refers to a line where the transfer is terminated.

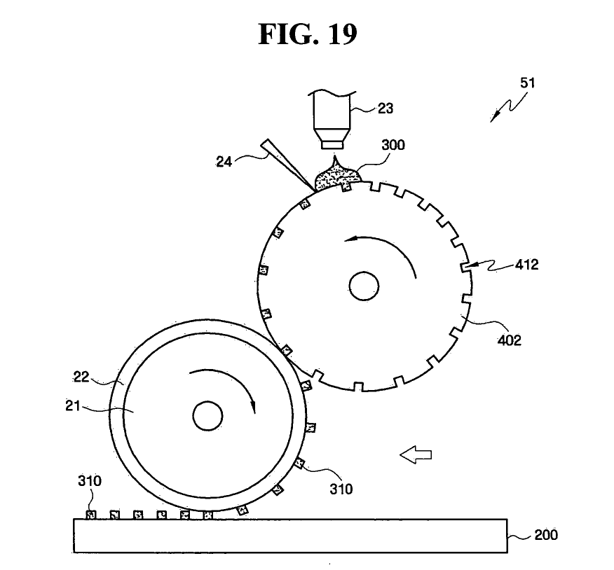

The printing plate 402 can also be applied to a method according to an embodiment of the invention of forming an array of spacers. FIG. 19 is a sectional view illustrating a method of forming the array of spacers using the printing plate shown in FIG. 18A by way of example.

Referring to FIG. 19, spacer-containing ink 300, which is supplied from an ink supply device 51 to a cylindrical printing plate 402, fills grooves 412 by means of a blade 24 while rotating the printing plate 402. While the printing plate 402 is continuously rotated, ink patterns 310 are transferred to a transfer sheet 22 of a transfer roller 21 in contact with the printing plate 402. The ink patterns 310 transferred from the transfer sheet 33 are retransferred to a second substrate 200 that moves relative to the rolling direction of the transfer roller 21. That is, the ink filling, the transfer, and the retransfer are continuously performed at the same time. Then, the ink patterns 310 are subjected to subsequent processes such as curing and drying to form the array of spacers.

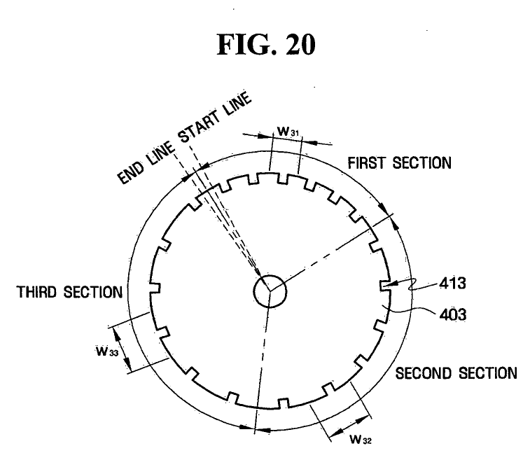

FIG. 20 illustrates a printing plate 403 according to yet another embodiment of the present invention. The printing plate 403 is the same as the printing plate 402 according to the embodiment shown in FIG. 18B except that grooves 413 are divided into sections, and the grooves 413 of each section are arranged in an equally spaced fashion. Referring to FIG. 20, the grooves 413 are divided into three sections. A distance W₃₃ between the grooves 413 in a third section containing the end line is greater than a distance w₃, between the grooves 413 in a first section containing the start line. A distance w₃₂ between the grooves 413 in a second section is greater than the distance w₃₁ and smaller than the distance w₃₃. That is, even though the grooves 413 in each section are arranged in an equally spaced fashion, a distance between the grooves 413 increases from the start line to the end line in the following order: w₃₁<w₃₂<w₃₃. Furthermore, even though the grooves 413 in each section are arranged in an equally spaced fashion, since the width of each section is smaller than the full width of the grooves 413, a distance error of ink patterns due to the arrangement of the grooves 413 in an equally spaced fashion in each section is negligible. Therefore, an array of spacers can be formed within non-TFT light-shielding regions of a substrate.

The above-described embodiments have illustrated that spacers can be formed on a second substrate, but the present invention is not limited thereto. Spacers may also be formed on a first substrate. In this case, the spacers are disposed on light-shielding regions of the first substrate, such as non-TFT light-shielding regions. Furthermore, the structures and manufacturing method of first and second substrates can be interchanged. For example, with respect to a first substrate, a semiconductor layer and data lines can be patterned using a single mask. The first substrate including the semiconductor layer and the data lines patterned using the single mask is also within the scope of an embodiment of the present invention. Since a person skilled in the art can sufficiently analogize the technical contents which are not described in various experimental examples of the present invention, a detailed explanation thereof is not given so as not to unnecessarily obscure aspects of the present invention.

As described above, according to a roll printing apparatus of an embodiment of the present invention, ink patterns having a predetermined distance can be accurately formed on a large-sized substrate. Furthermore, the use of the roll printing apparatus according to an embodiment of the present invention enables accurate alignment on light-shielding regions of the array of spacers of a display device, thereby enhancing the aperture ratio and attaining a highly accurate cell gap.

Those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A roll printing apparatus comprising:
a printing plate including an array of a plurality of grooves arranged equally spaced in a first direction, having substantially the same depth as a cell gap of a display panel including two opposing substrates, and extending in a second direction perpendicular to the first direction wherein a distance between each of the plurality of grooves is greater at an end line than at a start line; and
a transfer roller including a transfer sheet for transferring ink that is filled in the plurality of grooves to one of the substrates.

2. The roll printing apparatus of claim 1, wherein the distance between each of the plurality of grooves gradually increases from the start line to the end line in the second direction.

3. The roll printing apparatus of claim 1, wherein the plurality of grooves are divided into two or more sections equally spaced in the second direction, wherein a distance between each of the plurality of grooves of the two or more equally spaced sections becomes greater as the section is closer to the end line.

4. The roll printing apparatus of claim 1, wherein the transfer roller rolls on the printing plate in the second direction to transfer ink patterns that is filled in the grooves to the transfer sheet.

5. The roll printing apparatus of claim 4, wherein the transfer roller rolls on the one of the substrates to retransfer the ink patterns transferred on the transfer sheet to the one of the substrates.

6. The roll printing apparatus of claim 5, wherein the transfer roller retransfers the ink patterns to the one of the substrates in an equally spaced manner in the rolling direction of the transfer roller.

7. The roll printing apparatus of claim 1, wherein the ink contains spacers.

8. A printing plate comprising an array of a plurality of grooves having substantially the same depth as a cell gap of a display panel including two opposing substrates, wherein the plurality of grooves are arranged equally spaced in a first direction and extend in a second direction perpendicular to the first direction, a distance between each of the plurality of grooves being greater at an end line than at a start line.

9. The printing plate of claim 8, wherein the distance between each of the plurality of grooves gradually increases from the start line to the end line in the second direction.

10. The printing plate of claim 8, wherein the plurality of grooves are divided into two or more sections equally spaced in the second direction, wherein a distance between each of the plurality of grooves of the two or more equally spaced sections becomes greater as the section is closer to the end line.

11. A method of manufacturing a printing plate, the method comprising:
filing an array of a plurality of grooves formed on a test printing plate with ink, wherein a distance between each of the plurality of grooves is the same as a distance between spacers of display panel including two opposing substrates;
rolling a transfer roller including a transfer sheet on the test printing plate to transfer ink patterns from the grooves to the transfer sheet;
retransferring the ink patterns from the transfer sheet to a test substrate; and
comparing a distance between the ink patterns retransferred to the test substrate and a distance between the spacers and correcting the distance between the grooves.

12. The method of claim 11, wherein the correcting of the distance between the grooves is performed based on the following equation:
$$Wp = \frac{{Wt}_{1}^{2}}{{Wt}_{2}}$$
where Wₚ is a full width between the start and end lines of the grooves in the rolling direction, Wₜ₁ is a full width between the start and end lines of the spacers in the rolling direction, and Wₜ₂ is a full width between the start and end lines of the retransferred ink patterns in the rolling direction.

13. A method of manufacturing a display device, the method comprising:
filling an array of a plurality of grooves formed a printing plate with spacer containing ink, the printing plate including an array of a plurality of grooves arranged equally spaced in a first direction, having substantially the same depth as a cell gap of a display panel including two opposing substrates, and extending in a second direction perpendicular to the first direction wherein a distance between each of the plurality of grooves is greater at an end line than at a start line;
rolling a transfer roller including a transfer sheet on the printing plate to transfer ink patterns from the grooves to the transfer sheet; and
retransferring the ink patterns from the transfer sheet to one of the substrates.

14. The method of claim 13, wherein the distance between each of the plurality of grooves gradually increases from the start line to the end line in the second direction.

15. The method of claim 13, wherein the plurality of grooves are divided into two or more sections equally spaced in the second direction, wherein a distance between each of the plurality of grooves of the two or more equally spaced sections becomes greater as the section is closer to the end line.

16. The method of claim 13, wherein the one of the substrates includes a plurality of pixels arranged in a matrix shape, and the distance between each of the plurality of grooves arranged in the first direction is substantially the same as a gap between each of the plurality of pixels adjacent in a predetermined direction.

17. The method of claim 13, wherein the rolling of the transfer roller is performed from the start to end line of the grooves in the second direction.

18. The method of claim 13, wherein the one of the substrates includes lattice-shaped light-shielding patterns, and the retransferring of the ink patterns comprises retransferring the ink patterns to the light-shielding patterns of the substrate.

19. The method of claim 13, wherein the retransferring of the ink patterns comprises retransferring the ink patterns to the one of the substrates in an equally spaced fashion in the rolling direction of the transfer roller.

20. The method of claim 19, wherein the one of the substrates comprises a plurality of pixels arranged in a matrix shape, and a distance between the retransferred ink patterns in the rolling direction is the same as a distance between the pixels in the rolling direction.
